(19) United States
(12) Patent Application Publication
(10) Pub. No.: US 2011/0130274 A1
(43) Pub. Date: Jun. 2, 2011

(54) Method for preparing radioactive-substance adsorbent depositing on a carriable structure

(76) Inventors: Shih-Han Wang, Yangmei Township (TW); Ming-Tsai Liang, Dashu Township (TW); Chih-Ching Chang, Zhubei City (TW); Chi-Hung Liao, Sanchong City (TW); Chao-Yuh Chen, Zhudong Township (TW); Yih Ping Chen, Longtan Township (TW)

(21) Appl. No.: 12/591,756

(22) Filed: Dec. 1, 2009

(51) Int. Cl. B01J 20/22; B01J 20/00; B01J 20/10

(52) U.S. Cl. 502/401; 502/400; 502/407

(57) ABSTRACT

A method for preparing radioactive-substance adsorbent depositing on a carriable structure is revealed. The method uses a supercritical fluid to mix a first solution with a carrier. The first solution includes an extractant dissolved in a first solvent. By low surface tension and high permeability of the supercritical fluid, the extractant in the first solution deposit evenly on the carrier so as to form an adsorbent. Thus the adsorbent formed provides better adsorptivity for the radioactive substances.

### BACKGROUND OF THE INVENTION

1. Field of Invention

The present invention relates to a method for preparing radioactive-substance adsorbent depositing on a carriable structure that improves polymer properties by means of supercritical fluid.

2. Description of Related Art

A majority of Greater-Than-Class-C radioactive waste (GTCC) contains transuranic (TRU) waste that has a longer half-life so that the handling of such waste firstly requires removal of TRU waste for convenience of following treatment of radioactive substances processes. The way removing TRU is by solvent extraction with highly selective extractant such as TRUEX, DIAMEX, DIDPA, SETFICS and SANEX mentioned in ┌Extraction of selected mono- to tetravalent metal ions by 2,6-di(5,6-dialkyl-1,2,4,-triazin-3-yl)pyridines.┘ of Z. Kolarik, Solvent Extr. Ion Exch. 21(3), 381 (2003) and ┌Extraction of Am(III) and Eu(III) nitrates by 2,6-di(5,6-dipropyl-1,2,4-triazin-3-yl)pyridines┘ of Kolarik, Z., Mullich, U., and Gassner, F. (1999) Solvent Extr. Ion Exch., 17 (5):1155. Although the extraction efficiency of solvent extraction with highly selective extractant is significant, the formation of the third phase after extraction must require further treatment in following waste treatment. In order to solve such problems, the extraction chromatography technique is developed, coupling the selectivity feature of the extractant with easy operation and the multistage character of the chromatographic processes. Thus for removal of TRU from GTCC, the extraction chromatography is an optimal method.

In the extraction chromatography, the selection of extractant is an important issue. The extractant used in extraction chromatography has to meet several important criteria: (1) capable of extracting trivalent radioactive elements from acid medium, (2) soluble in n-Dodecane, (3) no formation of the third phase, (4) anti-corrosive, and (5) stable toward ionization radiation. Thus the most common extractants used are as the follows: carbamoyl dihexyl methyl phosphonate (CMP), octyl(phenyl) N,N-diisobutyl carbamoyl methyl phosphine oxide (CMPO), (N,N0,N,N0 dimethyl dibutyl tetradecyl malonamide (DMDBTDMA) and Cyanex series such as Cyanex923, Cyanex301. Most of the extractants have a chemical structure similar to that of chelating agents. The acidic range of CMPO being applied is larger than the others and CMPO also has good chemical stability. Thus CMPO is usually applied to the studies of extraction and removal of TRU.

Moreover, the extractant generally is a fluid that needs to be modified on a carrier for handling radioactive substances. Conventionally, the extractant is modified on the carrier by solution method so as to form a special structure for extracting radioactive substances and the carrier therein is usually made of hydrophilic materials such as silicon dioxide. Refer to FIG. 1, a flow chart of a conventional method for preparing a radioactive-substance adsorbent is revealed. This is a solution method consisting following steps:

Step S10: adding 0.5 g of CMPO into 20 ml of ethanol and stirring the solution until CMPO is completely dissolved;

Step S20: adding 0.2 g of silicon dioxide into the above solution and stirring the solution for 90 minutes;

Step S30: adding 5 ml of 1 mM 3-aminopropyltrimethoxysilane (APTES) to the solution and stirring the solution for 10 minutes (under nitrogen ambiance) to form a solution A.

Step S40: preparing a solution in which a ratio of deionized water and ethanol is 1:4 and stirring this solution for 5 minutes;

Step S50: adding 0.3 ml of tetraethoxysilane (TEOS) to the solution and stirring the mixture for 5 minutes to get a solution B;

Step S60: mixing the solution A with the solution B and stirring the mixture for 10 minutes;

Step S70: Adding 2 ml of ammonium hydroxide (NH₄OH) to the solution and stirring the solution for 1 hour to obtain a solution C;

Step S80: putting the solution C into a vacuum oven at 50° C. for 24 hours after washing several times with ethanol by centrifuging so as to obtain multi-layer porous structure of the adsorbent formed by silicon dioxide/CMPO extractant.

However, when CPMO is deposited on silicon dioxide by the solution method, the silicon dioxide particles are highly agglomerated. Refer to FIG. 2A, the scanning electron microscopy image shows the silicon dioxide particles modified by APTES. Then refer to FIG. 2B, the silicon dioxide particles are modified by CMPO. After treated by APTES via the solution method, the silicon dioxide particles agglomerate so that the extractant (CMPO) is unable deposited evenly on surfaces of each silicon dioxide particle. This leads to poor adhesion of CMPO on silicon dioxide and further causes bad TEOS coverage. The results also show agglomeration problems. Thus the multi-layer porous structure provides poor performance in TRU extraction.

Thus there is a need to develop a method for preparing radioactive-substance adsorbents depositing on a carriable structure to solve above problems. The radioactive-substance adsorbents depositing on a carriable structure not only improve adhesion of the extractant on the carrier but also enhance the adsorptivity of the radioactive substances on the adsorbent.

### SUMMARY OF THE INVENTION

Therefore it is a primary object of the present invention to provide a method for preparing radioactive-substance adsorbent depositing on a carriable structure that uses a supercritical fluid to mix a solution containing an extractant with a carrier so as to make the extractant deposited on the carrier evenly.

It is another object of the present invention to provide a method for preparing radioactive-substance adsorbent depositing on a carriable structure that uses carbon dioxide as the supercritical fluid which is recyclable.

In order to achieve the object, a method for preparing radioactive-substance adsorbent depositing on a carriable structure of the present invention includes the following steps: provide at least one carrier, a first solution and a fluid. The first solution contains a first solvent and an extractant. Mix together the carrier, the first solution and the fluid. Convert the fluid into a supercritical fluid so as to make the extractant added to the carrier to form the adsorbent. The method of the present invention further includes steps of: taking the adsorbent mixed within the supercritical fluid and adding with a second solution and then taking the adsorbent mixed with the supercritical fluid out of the second solution and adding with a third solution so as to coat a film on the adsorbent. Therefore, the extractant is deposited on the carrier evenly and a film is coated on the surface of the adsorbent evenly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of a conventional method for preparing an adsorbent;

FIG. 2A is a scanning electron microscope (SEM) image of a conventional adsorbent;

FIG. 2B is a SEM image of a adsorbent prepared by conventional method;

FIG. 3A is a flow chart showing steps of an embodiment of the present invention;

FIG. 3B is a schematic drawing showing structure of an adsorbent according to an embodiment of the present invention;

FIG. 3C is a schematic drawing showing structure of an adsorbent according to another embodiment of the present invention;

FIG. 4 is a flow chart for preparation of silicon dioxide particles;

FIG. 5 is a flow chart showing treatment of carriers;

FIG. 6A is a SEM image of the embodiment in FIG. 3B;

FIG. 6B is a SEM image of the embodiment in FIG. 3C;

FIG. 7 is a flow chart of another embodiment according to the present invention;

FIG. 8 is a flow chart of a further embodiment according to the present invention.

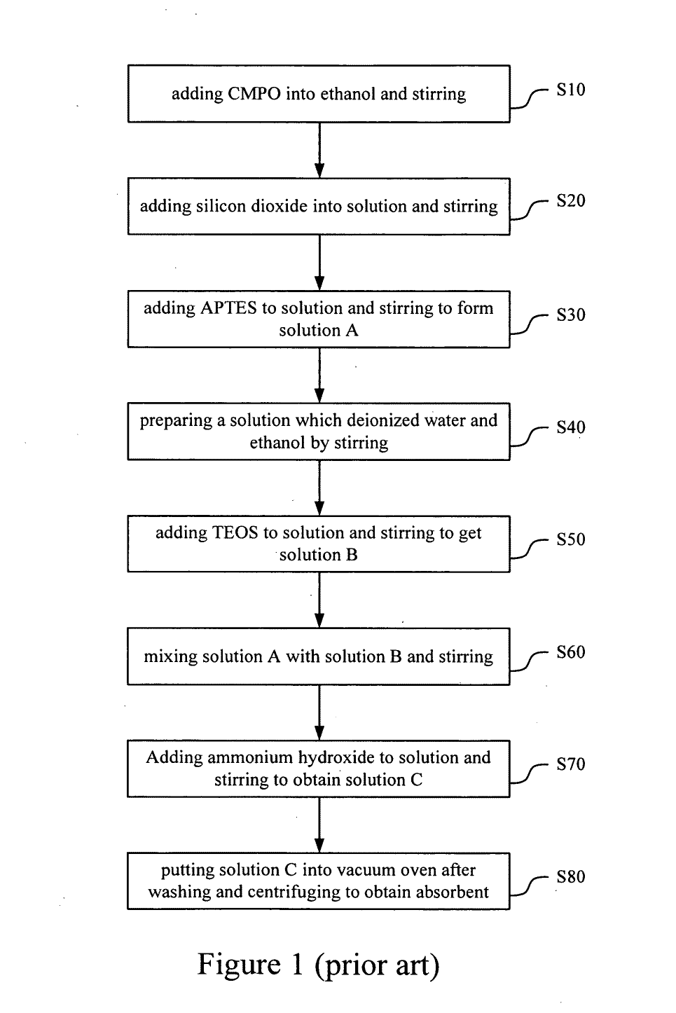

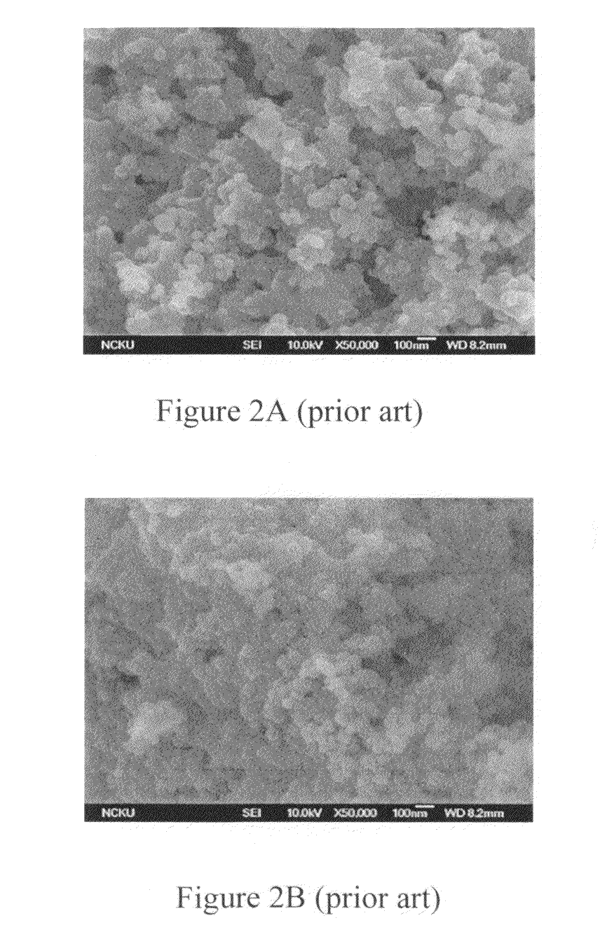

### DETAILED DESCRIPTION OF THE PREFERRED EMBODIMENT

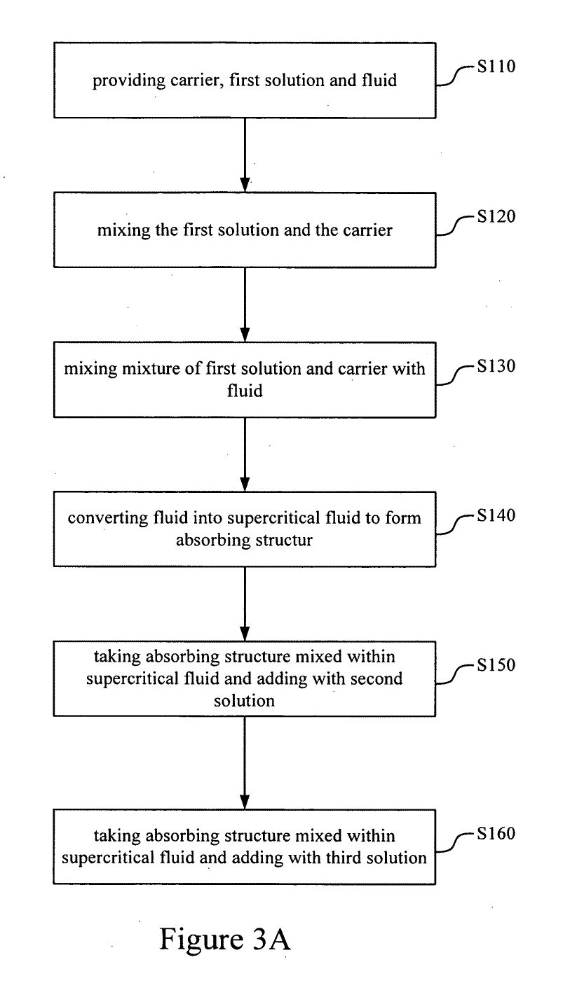

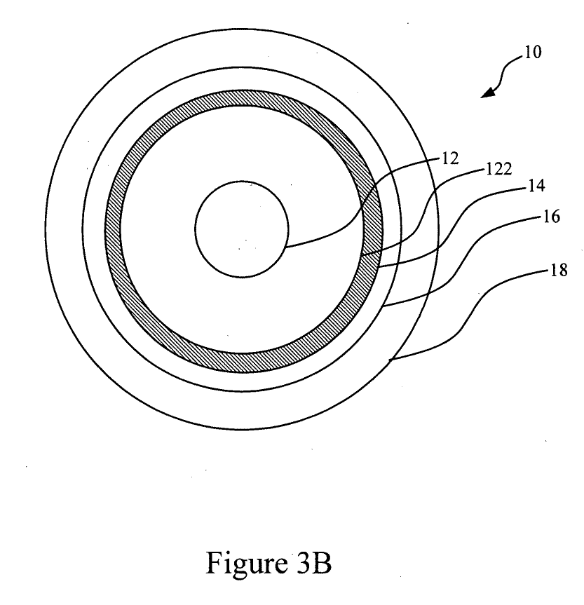

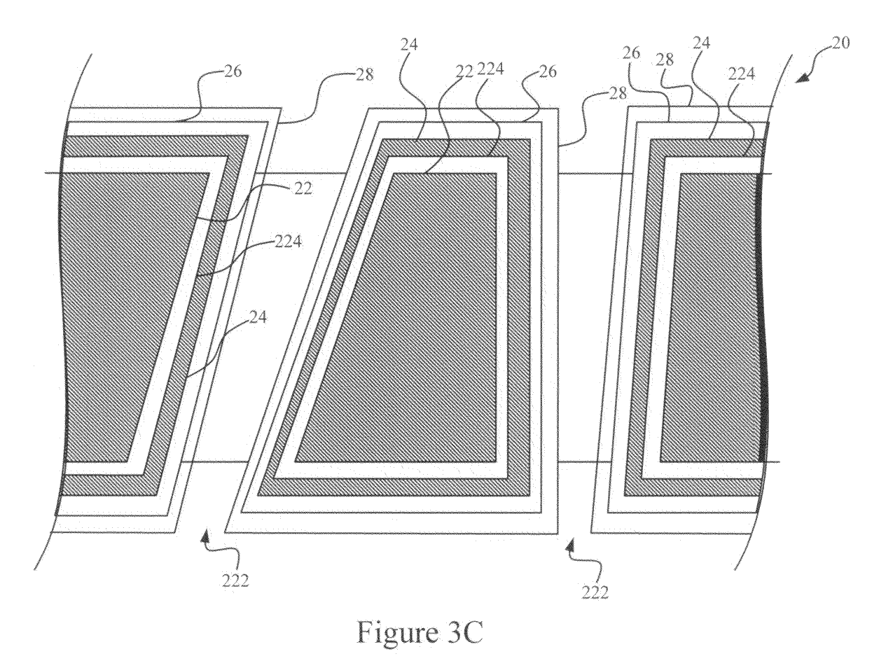

Refer to FIG. 3A, a flow chart of an embodiment according to the present invention is revealed. A method for preparing radioactive-substance adsorbent that adsorbs radioactive materials is to mix a solution containing extractants and silicon dioxide evenly by a supercritical fluid. In the beginning, refer to the step S110, providing at least one carrier, a first solution and a fluid. The first solution includes a first solvent and an extractant. In this embodiment, the fluid is carbon dioxide and the carrier is silicon dioxide. Besides CMPO, the extractant can be CMP or DMDBTDM A. Refer to the step S120, mixing the first solution and the carrier. Then take the step S130, mixing the mixture of the first solution and the carrier with the fluid and the fluid temperature is −4 degrees Celsius (° C.). Next run the step S140, converting the fluid into a supercritical fluid so as to make the extractant of the first solution deposit on the carrier to form the adsorbent. Then as shown in the step S150, taking the adsorbent mixed within the supercritical fluid and adding with a second solution that contains APTES and ethanol. At last, take the step S160, taking the adsorbent mixed within the supercritical fluid out of the second solution and add with a third solution so as to coat a film on the adsorbent. The third solution includes tetra-ethoxysilane (TEOS) and ethanol.

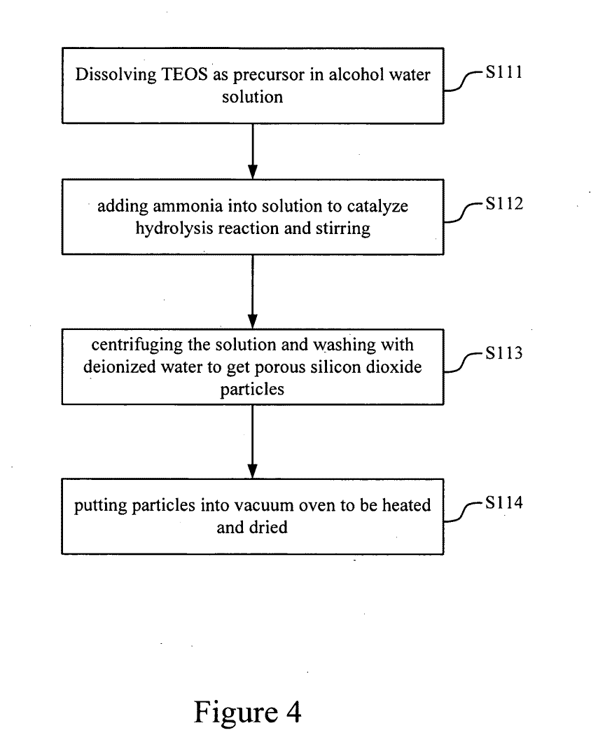

In the step S110, there are two sources of carriers. The first source is porous silicon dioxide particles prepared by a sol-gel method while the other is porous glass made from silicon dioxide. As shown in FIG. 4, a flow chart shows the steps for preparing porous silicon dioxide particles by the sol-gel method. In the beginning, take the step S111, TEOS used as a precursor is dissolved in dilute alcohol solution. Then as shown in the step S112, slowly adding ammonia into the solution to catalyze the hydrolysis reaction and the temperature is maintained at 30° C. and stirring the solution for 8 hours continuously. After completing the reaction, run the step S113, centrifuging the solution for separation and washing residual precipitate with deionized water so as to get porous silicon dioxide particles. Next take the step S114, putting the particles into a vacuum oven to be heated and dried at 80° C. for 24 hours so as to remove residual solvents on surfaces of porous silicon dioxide particles.

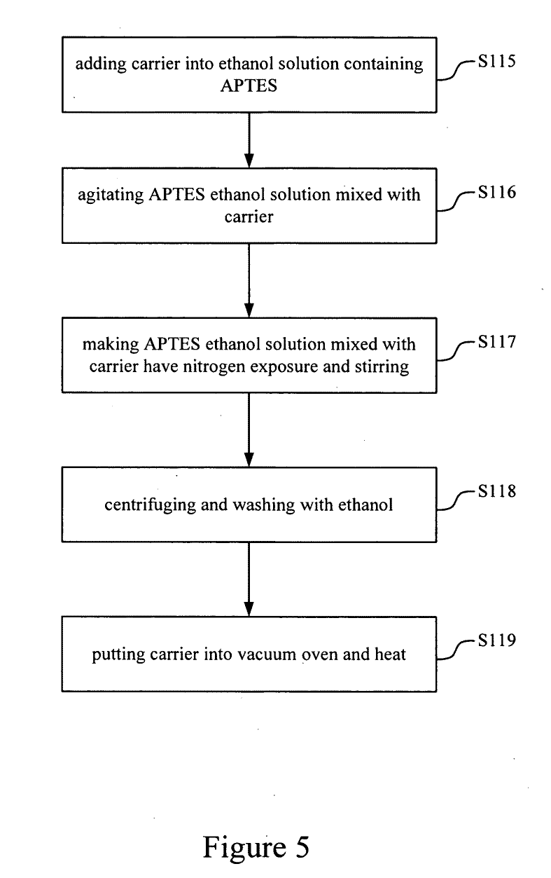

Moreover, in the step S110, both the self-prepared silicon dioxide particles or the commercial available porous glass needs to be treated before the step S120, as shown in FIG. 5. Refer first to the step S115, adding the carrier into an ethanol solution containing APTES. Then take the step S116, vibrating the mixture of APTES ethanol solution and the carrier. Next as shown in the step S117, mixing the APTES ethanol solution with the carrier under nitrogen atmosphere and stirring the solution. Later run the step S118, centrifuging for 5 minutes and washing residual precipitate with ethanol several times for removing physically adsorbed APTES. Then take the step S119, putting the carrier into a vacuum oven and heat at 80° for 24 hours. Thus the surface of the carrier will not have residual cruds or solvents.

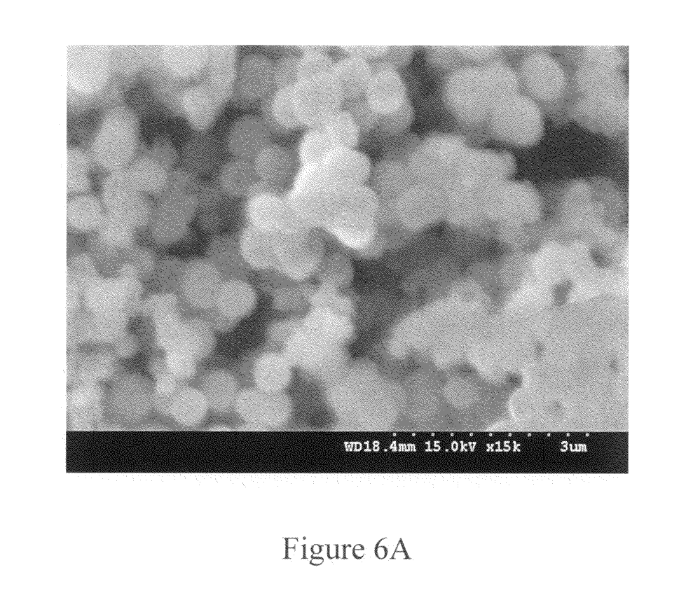

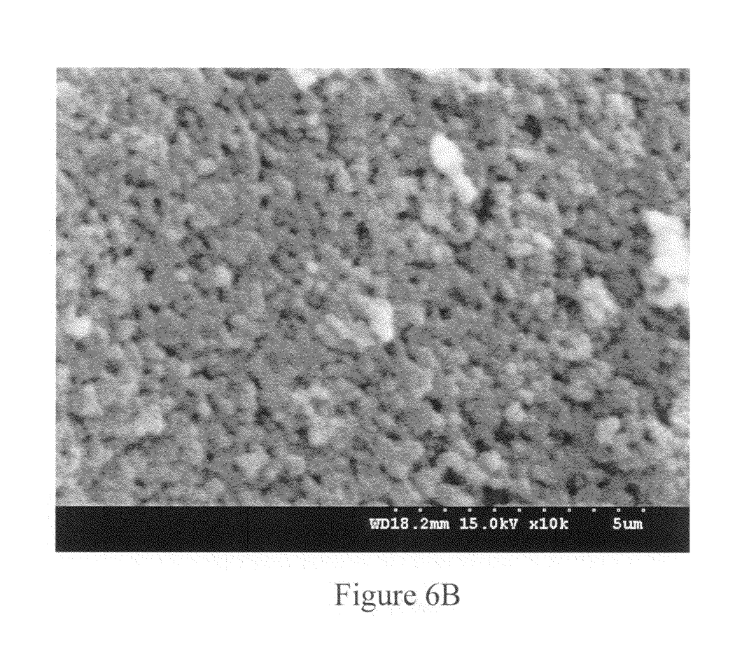

In the step S130, the first solution, the carrier and the fluid are mixed in a reactor. In the step S140, the pressure in the reactor is set at 150 bar, or 200 bar, the temperature is set at 250° C., 300° C., or 350° C. and the reaction time is 4 hours so as to obtain the adsorbent. The carrier of the present invention can be silicon dioxide particles or porous glass. As shown in FIG. 3B, when the carrier is a silicon dioxide particle, the adsorbent 10 includes a silicon dioxide particle 12, an extractant CMPO deposited layer 14, and a first APTES modification layer 122 between the silicon dioxide particle 12 and the adsorbent CMPO deposited layer 14. The adsorbent 10 is then modified by APTES in the step S150 and TEOS in the step S160. That means in the step S150, APTES forms a second APTES modification layer 16 on the outer surface of the extractant CMPO deposited layer 14. Next in the step S160, TEOS forms a TEOS protective layer 18 on the outer surface of the second APTES modification layer 16. Thus the TEOS protective layer 18 covers the second APTES modification layer 16. Refer to FIG. 6A, it shows the morphological appearance of the adsorbent 10 under the scanning electron microscopy.

As shown in FIG. 3C, when the carrier is porous glass, the adsorbent 20 consists of porous glass 22 and an extractant CMPO deposited layer 24 while the porous glass 22 includes a plurality of holes 222 and the extractant CMPO deposited layer 24 deposit on surfaces of the porous glass 22 and the holes 222. A first APTES modification layer 224 is disposed between the silicon dioxide particle 12 and the extractant CMPO deposited layer 14. The adsorbent 20 is modified by APTES in the step S150 and TEOS in the step S160. That means in the step S150, APTES forms a second APTES modification layer 26 on the outer surface of the extractant CMPO deposited layer 24. Next in the step S160, TEOS forms a TEOS protective layer 28 on the outer surface of the second APTES modification layer 26. Thus the second APTES modification layer 26 is coated on the extractant CMPO deposited layer 24 and the TEOS protective layer 28 covers the second APTES modification layer 26. Refer to FIG. 6B, it shows the morphological appearance of the adsorbent 20 under the scanning electron microscopy.

In this embodiment, the fluid is carbon dioxide. Thus when the carbon dioxide changes from a supercritical fluid to a non-supercritical fluid, it is recycled easily. Thus the fluid does not mix with the reacting solution and no problem arises. The generation of the third phase therefore is avoided. The adsorbent of the present invention can be applied to remove radioactive materials in fluid such as gas or liquid.

In summary, in the present invention, the first solution containing silicon dioxide is mixed with the supercritical fluid so as to make the extractant in the first solution evenly distributed over the surface of the carrier. Moreover, when the extractant is mixed in the supercritical fluid, it has smaller particle diameter so that the distribution of the extractant on the surface of the carrier is more evenly. Therefore, the supercritical fluid can increase the uniformity of the extractant deposited on the carrier surface and avoid the agglomeration.

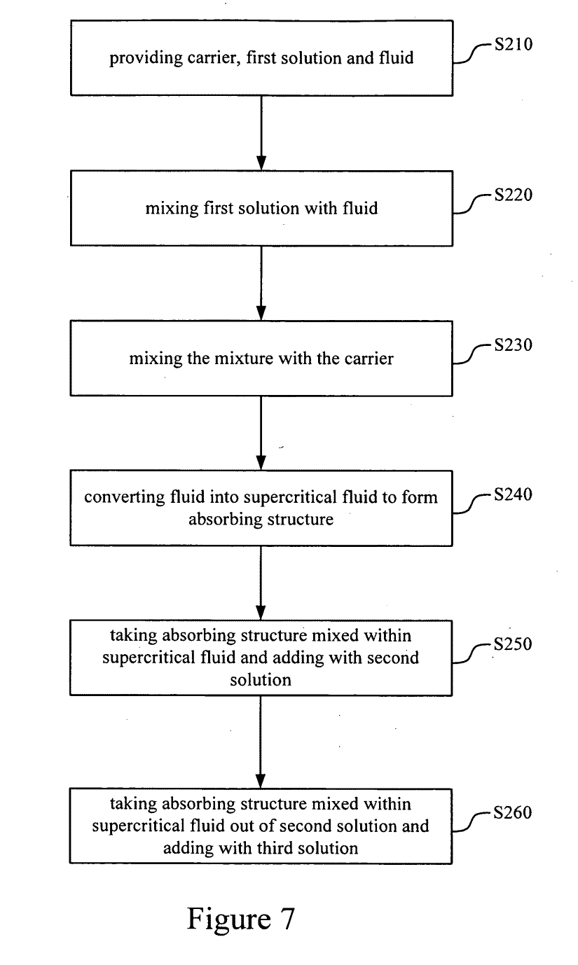

Refer to FIG. 7, a flow chart of another embodiment of the present invention is disclosed. The difference between this embodiment and the one in FIG. 3A is that the above embodiment is to mix the first solution with the carrier firstly and then add into the fluid while this embodiment is to mix the first solution with the fluid firstly and then mix the solution with the carrier. As shown in the step S210, provide at least one carrier, a first solution and a fluid. The first solution includes a first solvent and an extractant. In this embodiment, the fluid is carbon dioxide and the carrier is silicon dioxide. Besides CMPO, the extractant can be CMP or DMDBTDM A. Refer to the step S220, mixing the first solution with the fluid that has a temperature of −4° C. Then run the step S230, mixing the mixture of the first solution and the fluid, with the carrier. Later run the step S240, converting the fluid into a supercritical fluid so as to make the extractant of the first solution deposit on the carrier to form the adsorbent. Next as shown in the step S250, taking the adsorbent mixed within the supercritical fluid and adding with a second solution that contains APTES and ethanol. At last, run the step S260, taking the adsorbent mixed within the supercritical fluid out of the second solution and adding with a third solution so as to coat a film on the adsorbent. The third solution includes TEOS and ethanol.

In the step S240, the first solution, the carrier and the fluid are mixed in a reactor. In the step S250, the pressure of the reactor can be set at 150 bar or 200 bar and the temperature thereof can be set at 250° C., 300° C., or 350° C. while the reaction time is 4 hours.

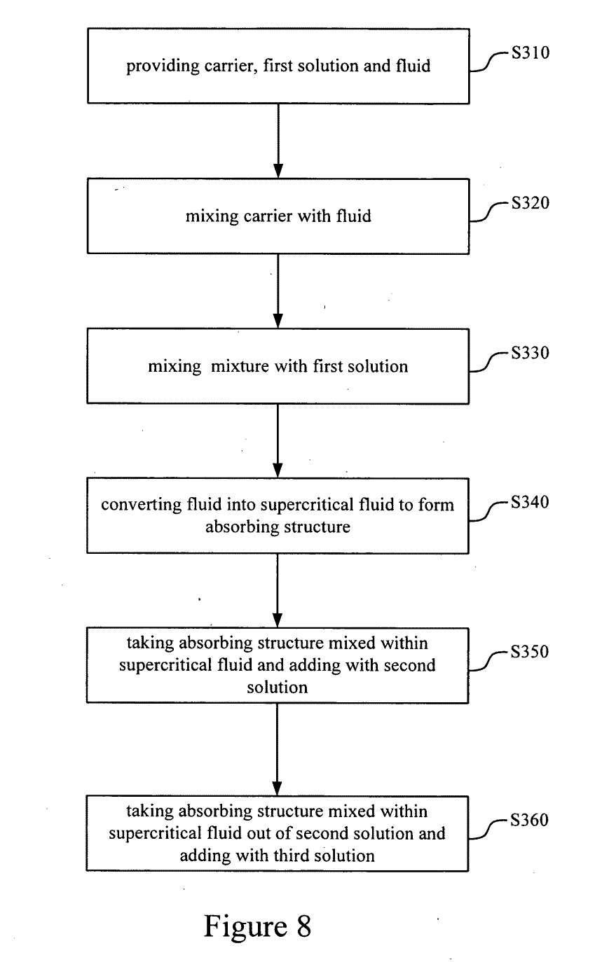

Refer to FIG. 8, a flow chart of a further embodiment of the present invention is disclosed. The difference between this embodiment and the one in FIG. 7 is that the above embodiment is to mix the first solution with the fluid firstly and then mix the solution with the carrier while this embodiment is to mix the fluid with the carrier firstly and then mix with the first solution. Firstly, take the step S310, providing at least one carrier, a first solution and a fluid. The first solution includes a first solvent and an extractant. In this embodiment, the fluid is carbon dioxide and the carrier is silicon dioxide. Besides CMPO, the extractant can be CMP or DMDBTDM A. As shown in the step S320, mixing the carrier with the fluid that has a temperature of −4° C. Then take the step S330, mixing the mixture of the carrier and the fluid, with the first solution. Next refer to the step S340, converting the fluid into a supercritical fluid so as to make the extractant of the first solution deposit on the carrier to form the adsorbent. Later run the step S350, taking the adsorbent mixed within the supercritical fluid and adding with a second solution that contains APTES and ethanol. Then as shown in the step S360, taking the adsorbent mixed within the supercritical fluid out of the second solution and adding with a third solution so as to coat a film on the adsorbent. The third solution includes TEOS and ethanol.

In the step S340, the first solution, the carrier and the fluid are mixed in a reactor. In the step S250, the pressure of the reactor can be set at 150 bar or 200 bar and the temperature thereof can be set at 250° C., 300° C., or 350° C. while the reaction time is 4 hours.

In summary, a method for preparing radioactive-substance adsorbent depositing on a carriable structure of the present invention is disclosed. A supercritical fluid is used to mix with the extractant and the carrier so as to make the extractant deposit on the carrier. Moreover, by low surface tension and high permeability features of the supercritical fluid, the extractant is distributed and deposited evenly on the surface of the carrier so as to obtain an adsorbent with high adsorptivity for the radioactive substances.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for preparing radioactive-substance adsorbent depositing on a carriable structure comprising the steps of:
providing at least one carrier, at least one first solution and at least one fluid and the first solution having a first solvent and an extractant;
mixing two of the carrier, the first solution and the fluid;
mixing the rest one of the carrier, the first solution and the fluid;
converting the mixed fluid into a supercritical fluid so as to make the extractant deposit on the carrier to form the adsorbent.

2. The method as claimed in claim 1, wherein after the step of forming the adsorbent, the method further includes the steps of:
taking the adsorbent mixed with the supercritical fluid and adding with a second solution; and
taking the adsorbent mixed with the supercritical fluid out of the second solution and adding with a third solution so as to coat a film on the adsorbent.

3. The method as claimed in claim 2, wherein the second solution includes the 3-aminopropyltrimethoxysilane (APTES) and the ethanol.

4. The method as claimed in claim 2, wherein the third solution includes the tetraethoxysilane (TEOS) and ethanol.

5. The method as claimed in claim 1, wherein before the step of providing at least one carrier, the method further includes a step of:
modifying the carrier.

6. The method as claimed in claim 5, wherein the step of modifying the carrier includes the steps of:
adding the carrier into an ethanol solution containing APTES;
vibrating the mixture of APTES ethanol solution and the carrier; and
mixing the APTES ethanol solution with the carrier under nitrogen ambiance and stirring the solution.

7. The method as claimed in claim 1, wherein the carrier is silicon dioxide.

8. The method as claimed in claim 1, wherein the fluid is carbon dioxide.

9. The method as claimed in claim 1, wherein the extractant is CMP, CMPO, or DMDBTDM A.

10. The method as claimed in claim 1, wherein the first solvent is ethanol.
